(19) United States
(12) Patent Application Publication
(10) Pub. No.: US 2015/0006278 A1
(43) Pub. Date: Jan. 1, 2015

(54) APPARATUS AND METHOD FOR DETECTING A DRIVER'S INTEREST IN AN ADVERTISEMENT BY TRACKING DRIVER EYE GAZE

(71) Applicant: HARMAN INTERNATIONAL INDUSTRIES, INC., Stamford, CT (US)

(72) Inventors: Davide DI CENSO, San Mateo, CA (US); Stefan MARTI, Oakland, CA (US); Ajay JUNEJA, Mountain View, CA (US)

(21) Appl. No.: 14/319,338

(22) Filed: Jun. 30, 2014

Related U.S. Application Data
(60) Provisional application No. 61/840,965, filed on Jun. 28, 2013.

(51) Int. Cl. G06Q 30/02; B60R 1/00; G06K 9/00

(52) U.S. Cl. CPC G06Q 30/0244; G06K 9/00791; G06K 9/00335; B60R 1/00; B60R 2300/105
USPC 705/14.43

(57) ABSTRACT

A controller for providing advertisements to a vehicle or a wearable housing, and a computer readable medium, when executed by one or more processors, performs an operation to provide an audio advertisement to the vehicle or wearable housing. A first signal input receives a first camera signal, a second signal input receives a second camera signal, and at least one signal output transmits to at least one acoustic transducer, which provides the audio advertisement to the user. The computer logic that may be arranged within the controller determines whether the direction of the captured images of the advertisements and the direction of the user's eye gaze correspond to one another, and, if so, the computer logic outputs the audio advertisement to the audio transducer.

### RELATED APPLICATIONS

This application claims the benefit of U.S. Provisional Application Ser. No. 61/840,965, filed on Jun. 28, 2013, the entire contents of which are incorporated by reference herein.

### TECHNICAL FIELD

Aspects disclosed herein generally relate to an apparatus and method for detecting a driver's interest in a visual advertisement by tracking driver eye gaze direction such that an audio advertisement that is generally associated with the visual advertisement is provided to the driver.

### BACKGROUND

Many different types of advertisements are provided for display to a driver in a vehicle in an effort to solicit interest. When driving, the driver may look at a visual street advertisement (e.g., a billboard) and attempt to remember information provided on the advertisement. In some cases, the driver may need to take his/her eyes off of the road to comprehend the information on the advertisement, distracting from the task of driving the vehicle. A number of street advertisements are not customized to the viewer because they are most often static in nature. Such static street advertisements are not equipped with the capability of becoming aware of a viewer's preferences and generally cannot include too much information in order to maintain readability. Further, radio advertisements are in most cases not meaningful for the driver, since they are neither personalized, nor customized.

### SUMMARY

Embodiments of a controller can provide advertisements to a user. The controller can include a first signal input that receives a first camera signal indicating a direction in which a user is looking. The controller can also include a second signal input that receives a second camera signal that includes captured images of one or more advertisements from the surrounding environment. The controller can also include a signal output that drives at least one acoustic transducer. The controller can also include computer logic programmed to determine a direction to each of the captured images of the advertisements and whether the indicated direction the user is looking corresponds to the direction of the captured image of the advertisements. Upon determining that the two directions correspond, the computer logic can determine the context of the one or more advertisements and output an audio advertisement that corresponds to the determined context via the signal output.

In various embodiments, a controller for providing advertisements can be provided in a wearable device. The controller can include a first signal input that can receive a first camera signal that indicates an eye gaze direction. The control can also include a second signal input that can receive a second camera signal that includes captured images of one or more advertisements from the surrounding environment. The controller can include a signal output that drives at least one acoustic transducer. The controller can also include computer logic programmed to determine the direction of each of the captured images of the advertisements and whether the indicated eye gaze direction corresponds to the determined direction of one of the captured images of the advertisements. Upon verifying that the two directions correspond, the computer logic can determine the context of the one of the one or more advertisements and output to the signal output an audio signal for an advertisement with context that matches the context of the one of the one or more advertisements. The first camera providing the first camera signal, the at least one second camera providing the second camera signal, and the at least one acoustic transducer can be arranged in at least one wearable housing.

A computer readable medium that comprises a program can perform an operation when the program is executed by one or more of the processors that input visual advertisements and outputs corresponding audio advertisements to a user. The program can determine a direction a user is looking. Then, the program can determine the locations for a plurality of advertisements around the user and whether the user is looking in a direction corresponding to one of the plurality of advertisements. The program can determine the context of the advertisement being looked at. The program can output an audio advertisement with context corresponding to the context of the advertisement being looked at.

The above advantages and various other advantages and features may be apparent from the following detailed description of one or more representative embodiments when taken in connection with the accompanying drawings.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 is a block diagram of a system controller according to various embodiments;

FIG. 2 is a block diagram for an embodiment of a system according to various embodiments arranged in a passenger vehicle;

FIG. 3 illustrates a method for providing an audio advertisement to a user, based on context from a visual advertisement being looked at by the user;

FIG. 4 is a block diagram for an embodiment of a system according to various embodiments arranged in a passenger vehicle;

FIG. 5A illustrates a method for providing an audio advertisement to a user, based on context from a visual advertisement being looked at by the user;

FIG. 5B illustrates a method for providing an audio advertisement to a user, based on context from a visual advertisement being looked at by the user;

FIG. 6 illustrates an exemplary scenario for determining if the driver is looking at the advertisement;

FIG. 7 is a block diagram for an embodiment of a system according to various embodiments arranged in a passenger vehicle;

FIG. 8 illustrates a method for providing an audio advertisement to a user, based on context from a visual advertisement being looked at by the user;

FIG. 9 depicts an exemplary scenario that illustrates a method for determining which advertisement a user is looking at;

FIG. 10 depicts an exemplary scenario that illustrates a method for determining which advertisement a user is looking at; and

FIG. 11 depicts an exemplary scenario that illustrates a method for determining a context of an advertisement being looked at by a user.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired.

It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

In various embodiments described herein can provide customized audio advertisements related to an advertisement (e.g., a billboard) that a user is interested in. The driver can be provided with information on specific products/companies/services of interest in a way that minimizes driver distraction.

In addition to advertisements, the user could also view road signs (e.g., related to accidents or other road hazards ahead, road closures, routes of travel, detours, and/or exits) to trigger the output of audio information related to the road signs. The system could also work with other visual information. For example, a driver may see road signs, such as traffic or road hazard alerts, highway interchange information, and the like, such that the user can receive audio data that supplement the visual information. The visual advertisements and/or other information a user may see is referenced herein as visual information.

Various embodiments can be arranged in a vehicle such that audio advertisements related to billboards or other advertisements that the driver looks at can be played through an audio system in the vehicle. Various other embodiments can provide for customized audio advertisements to a wearable housing based on a user's interest of an advertisement (e.g., a billboard) as observed via eye gazing tracking, image recognition, and/or location data. The user can similarly be provided with information on specific products/companies/services of interest in a convenient way.

Embodiments can include various multimodal apparatuses that can, among other things, observe the driver's eye gaze and detect glances to billboards and other forms of visual advertising such that relevant audio advertisements can be played through an in-vehicle or portable infotainment system in response to the user's interest to the billboard. Such embodiments may understand the user's interest in a specific visual advertisement by, but not limited to, the length of the user's glance or the detection of multiple glances to the same billboard. In response to the user's interest in the visual advertisement, a specific audio advertisement related to the content of the visual advertisement can be played via an infotainment system, thereby providing the user with more information about the product, company, service, etc. being advertised in the visual advertisement.

Such audio advertisements may be customized to include personalized information for the user. For example, information on where to purchase the product closest to the current location of the user may be provided. By allowing access to personal data of the user (e.g., driver's location, heading direction, navigation destination, exact route, driver's previous interest in a product, etc.), a customized experience may be unlocked to provide tailored advertisements that may include special offers or specific price quotes.

In various embodiments, a driver may gather information and receive useful advertisements without being distracted from the primary task of driving. By detecting the driver's prolonged and/or multiple eye contact(s) with the billboards, various embodiments disclosed herein can offer a meaningful and contextualized advertisement that is of interest to the driver. Information may be customized based on what billboards and advertisements the driver looked at while driving and detailed auditory information can be provided to the driver such that the driver is not distracted while attempting to read the details on a street advertisement. The driver can keep his/her eyes on the road and receive the information of interest through the in-vehicle infotainment system without having to type on a keypad or keyboard or without having to speak commands thereby minimizing driver distraction.

In various embodiments, a user may receive audio advertisements related to visual advertisements (e.g., billboards) during non-vehicular transit as well (e.g., while walking or riding a bicycle). In various embodiments, a controller can detect a user's prolonged and/or multiple eye contact(s) with a visual advertisement. The controller can then output to an audio transducer (e.g., a speaker) an audio advertisement related to the visual advertisement. Information may be customized based on what billboards and advertisements the user looked at while in transit and detailed auditory information can be provided to the user. The user can receive the advertisement with convenience and without interfering with the user's activity.

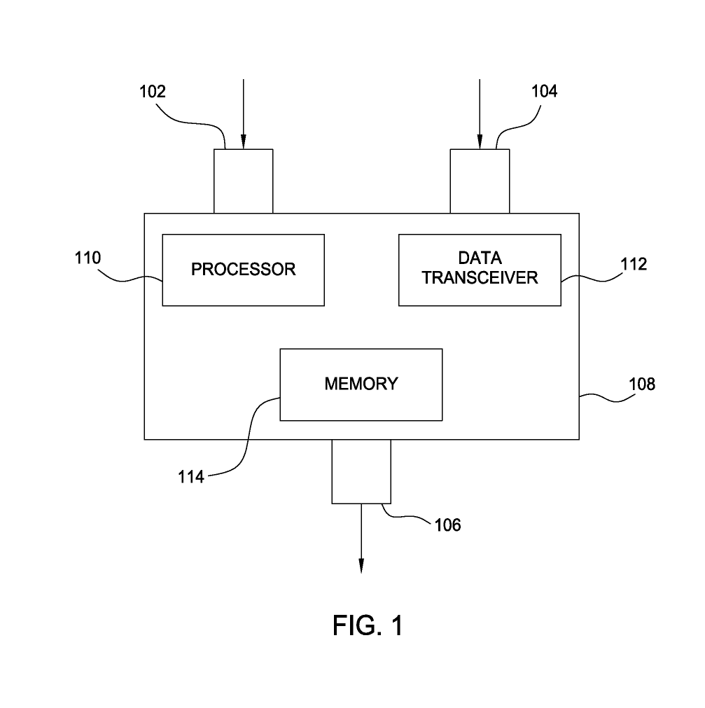

Referring now to FIG. 1, in various embodiments, a controller 108 can include a first signal input 102 and a second signal input 104. The controller 108 can also include a signal output 106. The first signal input 102 can receive a first camera signal. The first camera signal can be transmitted from a first digital imager (e.g., a digital camera) that can indicate an eye gaze direction of a user. The second signal input 104 can receive a second camera signal from a second digital imager (e.g., a digital camera) that can capture images of at least a portion of the user's environment. In some instances, multiple digital imagers can be used in combination to provide a larger field of view of the user's environment. The signal output 106 can transmit signals to an acoustic transducer, which, in turn, can reproduce the transmitted signal as audio (e.g., an audio advertisement). In various embodiments, the controller 108 can include a computer processor 110 (also referred to herein as “computer logic”). The computer processor 110 can analyze the captured image of the user's environment to identify advertisements in the advertisement. The computer processor 110 can analyze the first camera signal received on the first signal input 102 and the second camera signal received on the second signal input 104 to determine if the indicated eye gaze direction corresponds to a direction of an identified advertisement in captured images of the user's environment. In the event the computer processor 110 determines that the indicated eye gaze direction from the first camera signal corresponds to a direction of an identified advertisement from the second camera signal, the computer processor 110 can transmit an output signal (e.g., an audio advertisement related to the identified advertisement) to the signal output 106.

In various embodiments, the controller 108 can include a memory module 114 that can store a plurality of audio advertisements. The processor 110 can select a particular audio advertisement among the plurality that is related to the identified advertisement from the second camera signal. The processor 110 can then output the selected audio advertisement. For example, each audio advertisement can be stored as a computer audio file (e.g., an MP3 file), such that the computer processor 110 can select a file and execute the file. Executing such a sound file can result in an audio signal that can be output by the computer processor 110 to the signal output 106. In various embodiments, the controller 108 can include a data transceiver 112 (e.g., a Wi-Fi or cellular data connection) that enables the processor 110 to communicate with a remote computer system. The remote computer system can include a database of audio advertisements. The processor 110 can communicate with the remote computer system through the data transceiver 112 to retrieve audio advertisements. In various embodiments, the controller 108 can combine locally stored audio advertisements in memory 114 with audio advertisements accessed on a remote computer system through the data transceiver 112.

In various embodiments, the computer processor 110 can determine which audio advertisement is related to the identified advertisement from the second camera signal. For example, the processor 110 may use image recognition to identify people, objects, or places in an identified advertisement to identify a context (e.g., a name or a logo of a business or a product) of the advertisement. As another example, the processor 110 may use text recognition to identify a context. In various other embodiments, the processor 110 can send the image of the identified advertisement to a remote computer system through the data transceiver 112 to enable the remote computer system to perform the image analysis.

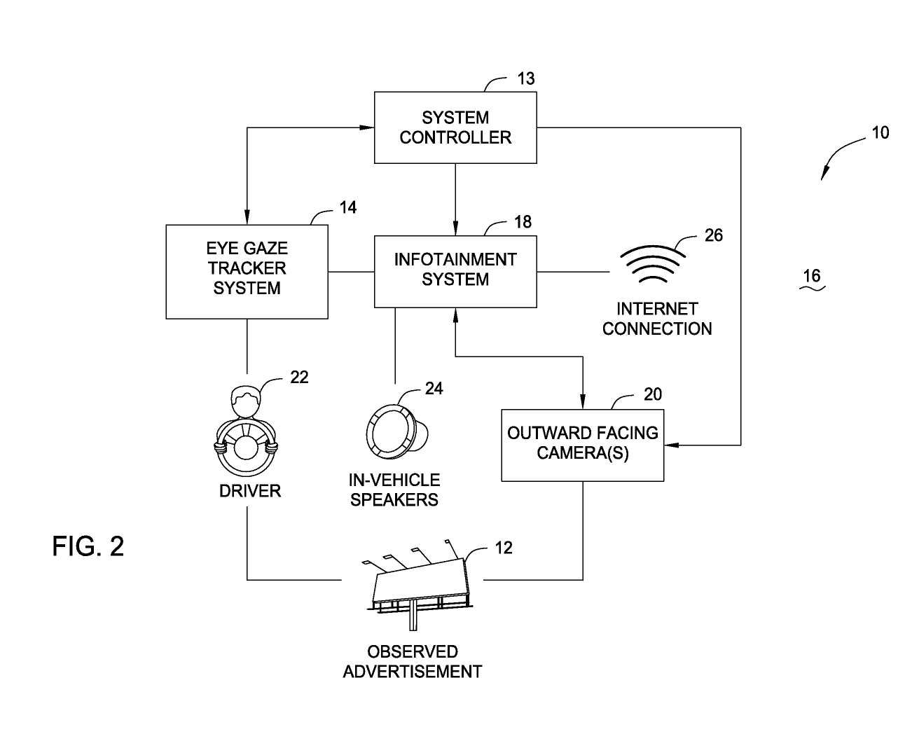

FIG. 2 illustrates an embodiment of a system 10 for providing audio advertisements corresponding to advertisements seen by a driver of a passenger vehicle. The system 10 can include a system controller 13 and an eye gaze tracker system 14 positioned about a vehicle 16. For example, the eye gaze tracker system 14 may include one or more eye gaze sensors arranged in a passenger compartment to detect head position and/or eye gaze direction of the driver 22. In various embodiments, the eye gaze tracker system 14 can include any number of eye gaze sensors (e.g., cameras) and an eye gaze controller (not shown). The system 10 can also include an infotainment system 18. For example, the infotainment system 18 can include a display screen (e.g., a display screen in a car that displays one or more of navigation data, climate control settings, radio stations, and the like) and a vehicle radio. The infotainment system 18 can be connected to in-vehicle speakers 24. The system 12 can also include one or more outward (or forward) facing cameras 20 (hereafter “camera 20” or “cameras 20”) positioned about the vehicle 16. The system controller 13 can communicate with the eye gaze tracker system 14 and the camera 20 for performing various operations as disclosed herein. The system controller 13 may be integrated within the infotainment system 18 or may be implemented outside of the infotainment system 18.

The eye gaze tracker system 14 can be configured to detect and track an eye gaze direction for a driver 22 while driving. The one or more eye gaze sensors of the eye gaze tracker system 14 can be mounted on a dashboard of the vehicle 16, on a headliner (or ceiling) of the vehicle 16, or any other location that is conducive to enable the eye gaze sensors to face a driver's face. Examples of eye gaze sensors are provided by Tobii® and SmartEye AB. Such eye gaze sensors may incorporate corneal-reflection tracking that is based on infrared illuminators. In another example, the eye gaze sensor may be a depth sensor that is time-of-flight based or stereoscopy which incorporates sensor processing middleware. Examples of these types of sensors are provided by PMDTec, PrimeSense®, and Seeing Machines'® EyeWorks™. In addition, the eye gaze sensor may be red, green, and blue (RGB)-based imagers with vision processing middleware. The eye gaze sensors may also be implemented as laser, radar, and ultrasound based sensors.

The eye graze tracker system can work continuously and can track any movement of the user's eye gaze, thereby measuring the changes in eye gaze direction as the vehicle is in motion (e.g., as the user is tracking an advertisement during transit, the system is measuring the rate of change of the eye gaze and calculating the distance from the user to the advertisement). An advertisement that is distant from the user will be tracked by a slower moving eye gaze, as opposed to an advertisement that is close, which would be tracked by a faster moving eye gaze.

In various embodiments, the various eye gaze sensors can track an orientation of the driver's 22 head in lieu of tracking the driver's eye gaze direction. Examples of this implementation are set forth by Seeing Machines® which provide, among other things, middleware that provides head orientation and/or head pose as a three dimensional vector (faceAPI). It is also recognized that the sensor may provide head orientation in a two-dimensional vector (e.g., by providing a horizontal head angle).

In various embodiments, the system 10 can be configured to determine if the driver 22 looks at an advertisement 12 for more than a predetermined amount of time (e.g., two seconds), a number of times exceeding a predetermined amount (e.g., two times), and/or for a total cumulative time exceeding a predetermined amount (e.g., the driver looks at an advertisement several times that add to a cumulative viewing time of two seconds). Such conditions may indicate an interest by the driver 22 with respect to the content of the advertisement 12. The system controller 13 can trigger the camera 20 to capture an image of the advertisement 12 for image recognition. Once the image of the advertisement 12 is recognized, the system controller 13 can transmit to the infotainment system 18 a related audio advertisement that is corresponds to (i.e., is related to or associated with) the advertisement 12. By playing the corresponding audio advertisement, the driver 22 may be able to keep his eyes on the road (rather than look at the advertisement for a longer period of time) and may be presented with additional information that is not provided on the advertisement. In certain instances, the audio advertisements may be stored on a remote computer system. The system controller 13 and/or the infotainment system 18 may communicate with the remote computer system over an internet connection 26 provided by a data transceiver.

In certain embodiments, the user may be provided with a button that the user or driver can push while momentarily looking at an advertisement in order to indicate interest in the advertisement. Allowing the driver to indicate interest in this alternative way may minimize the time it takes for the system to notice an advertisement of interest, thereby minimizing the time spent looking away from the road. The button that the driver can push could be any user interface element, including a physical button, an icon on a digital interface, a force measurement of the steering wheel (e.g., the driver pressing the left side of the steering wheel momentarily), a voice command, a facial cue, a hand gesture, or any other way to express to the system that it should follow the user's eye gaze.

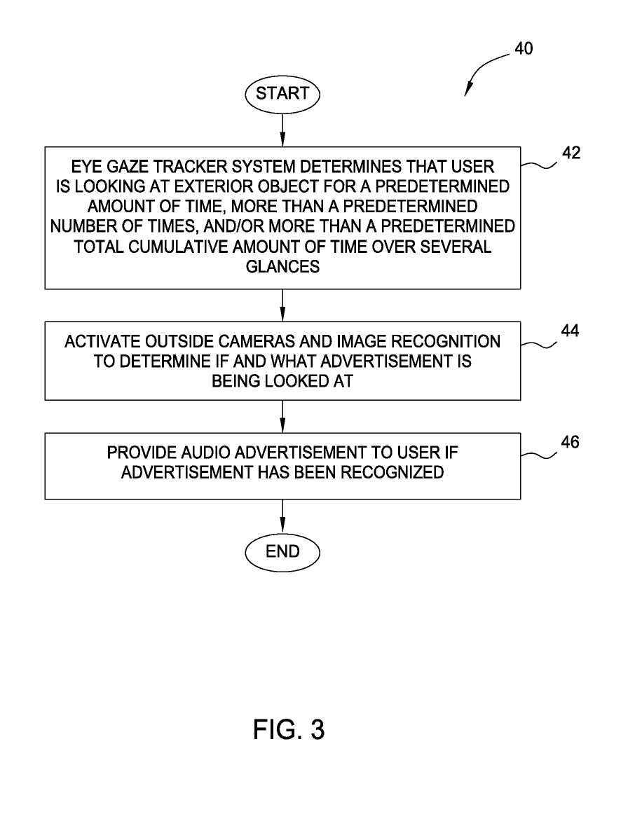

FIG. 3 illustrates an embodiment of a method 40 the system 12 can perform for providing an audio advertisement related to the advertisement 12 shown in FIG. 2. In operation 42, the system controller 13 can monitor the direction of a driver's 22 eye gaze to determine if the driver 22 is interested in the advertisement 12 (among possible several advertisements visible to the outward facing camera(s) 20). For example, if the driver looks at the advertisement for a predetermined amount of time, then the system controller 13 can determine that the driver is interested in the advertisement 12. As another example, if the driver looks at the advertisement a number of times exceeding a predetermined amount, then the system controller 13 can determine that the driver is interested in the advertisement 12. As another example, if the driver looks at the advertisement 12 for a total cumulative time exceeding a predetermined amount (e.g., if he looks at the advertisement 12 several times and the total amount of time spent looking at the advertisement 12 exceeds a predetermined amount of time), then the system controller 13 can determine that the driver 22 is interested in the advertisement 12. If the system controller 13 determines that the driver is interested in a particular advertisement (e.g., advertisement 12), then the method 40 can move to operation 44.

In operation 44, the system controller 13 can control and/or activate the camera(s) 20 to capture an image of the advertisement 12 and/or to perform image recognition of the same. The camera(s) 20 can include any combination of hardware and software for capturing the image of the advertisement 12 and for performing image recognition. The camera(s) 20 may be implemented as an RGB imager. Thus, the image captured by the camera(s) 20 can then be processed and matched with information corresponding to known advertisements to recognize content and/or context (e.g., brand, product, company, service, message, logo etc.). In various embodiments, the information corresponding to known advertisements can be obtained through a wireless connection 26. In one example, this condition may be based on various products as provided by VisionIQ® image recognition. Once the image of the advertisement 12 has been captured and/or analyzed based on image recognition, the method 40 can move to operation 46.

In operation 46, the camera(s) 20 can transmit information about the advertisement 12 to the infotainment system 18 and/or to the system controller 13. The infotainment system 18 can then provide an audio related advertisement via in-vehicle speakers 24. The audio related advertisement can be associated with, correspond to, or be related to the context of the advertisement 12 viewed by the driver 22. It is recognized that the infotainment system 18 may include a radio for interfacing with the in-vehicle speakers 24 for playing back the audio related advertisement. The infotainment system 18 may also include, for example, an Aha® radio by Harman® in which such information is played back either via the driver's 22 cell phone or through the in-vehicle speakers 24 via an interface with the driver's 22 cell phone. It is also recognized that the in-vehicle speakers 24 may be replaced with a head-worn headset (e.g., a Bluetooth® headset), hearing aid devices, wearable loudspeakers, etc.

The infotainment system 18 may be coupled to a wireless connection 26 for communication with a server (not shown). For example, the server may provide the audio related advertisement via the wireless connection 26 to the infotainment system 18 for playback to the driver 22. It is recognized that the audio related advertisement may provide the driver 22 with similar information as provided in the advertisement 12 or different information than that provided in the advertisement 12 on the billboard.

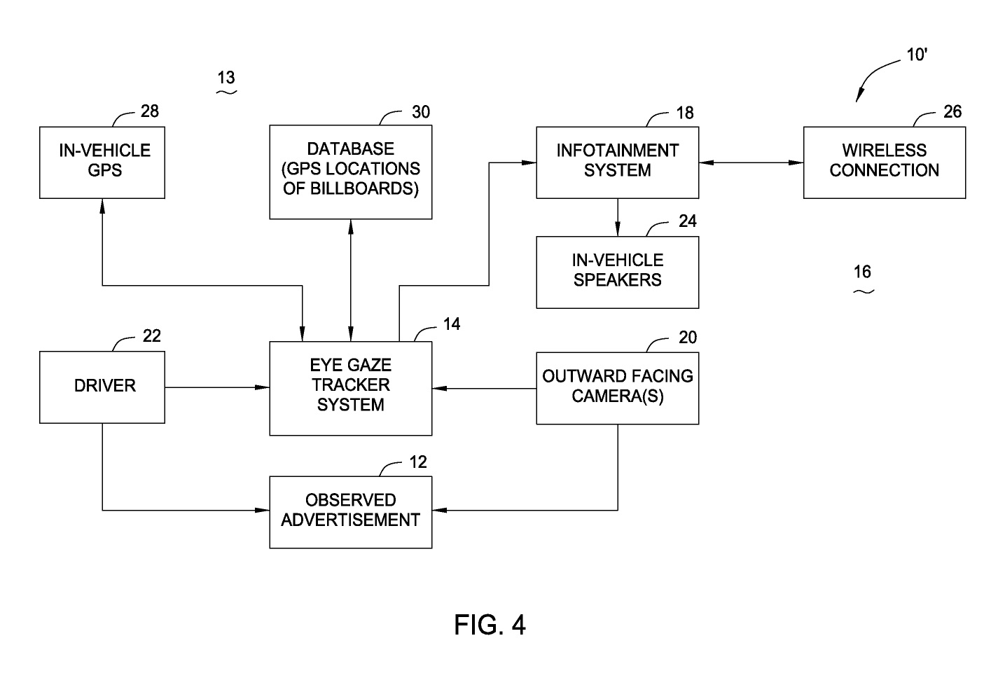

FIG. 4 depicts another embodiment of a system 10′ for providing an audio advertisement related to an advertisement 12 that a driver shows interest in. The system 10′ can include an in-vehicle global positioning system (GPS) module 28 that can provide GPS coordinates of the vehicle 16. GPS as noted herein generally refers to any and/or all global navigation satellite systems, which include GPS, GLONASS, Galileo, BeiDou, etc. The apparatus 10′ can further include a database 30 that can store locations (e.g., GPS coordinates) of different advertisements that the driver may see as well as audio advertisements that are related to each of the advertisements. In one example, the database 30 may be onboard the vehicle 16. In another example, the database 30 may be located remotely (e.g., a remote computer system), and the vehicle 16 can communicate wirelessly with the remote computer system via the wireless connection 26 to provide the GPS coordinates of the advertisement 12 so that the corresponding audio advertisement can be retrieved.

In the embodiment depicted in FIG. 4, the eye gaze tracker system 14 may perform the functions of the system controller 13 in FIG. 2. Thus, as the vehicle 16 approaches one or more of the GPS locations of advertisements stored in the database 30 (e.g., comes within a predetermined distance of the advertisements), the eye gaze tracker 14 can initiate the operation of tracking the eye gaze of the driver 22 to determine if the driver 22 is interested in the content of the advertisement 12 (as described above). While the eye gaze tracker system 14 tracks the eye gaze of the driver 22, the GPS module 28 can determine GPS coordinates for the vehicle 16. The system 10′ may also determine an orientation of the vehicle by determining a direction of travel from successive GPS coordinates of the vehicle 16 and/or from a compass in the vehicle 16. By determining a direction of the driver's 22 eye gaze relative to the orientation of the vehicle, a direction of the driver's 22 eye gaze (e.g., relative to magnetic north) can be determined. The system 10′ can compute a vector with an origin at the determined GPS coordinates and a direction extending in the determined direction of the driver's 22 eye gaze. If the computed vector intersects a location of an advertisement in the database 30, then the system 10′ can determine that the driver 22 is looking at the advertisement.

As discussed above, the eye gaze tracker system 14 can determine whether the driver 22 in interested in an advertisement that he/she has looked at. If the eye gaze tracker system 14 determines that the driver 22 is interested in a particular advertisement 12, then the eye gaze tracker system 14 can trigger the camera(s) 20 to capture an image of the advertisement 12. The camera(s) 20 can perform image recognition to determine the content of the advertisement 12. Alternatively, the vehicle 16 may access the database 30 and compare the captured image to data stored therein to ascertain the content of the advertisement 12. Still further, the vehicle 16 may access the database 30 to obtain the GPS coordinates for geocoded billboard locations (e.g., provided by advertising companies, etc.) and match the vehicle's current location (as provided by the in-vehicle GPS 28) and driver 22 gaze direction against the geocoded billboard locations to ascertain the advertisement of interest to the driver 22.

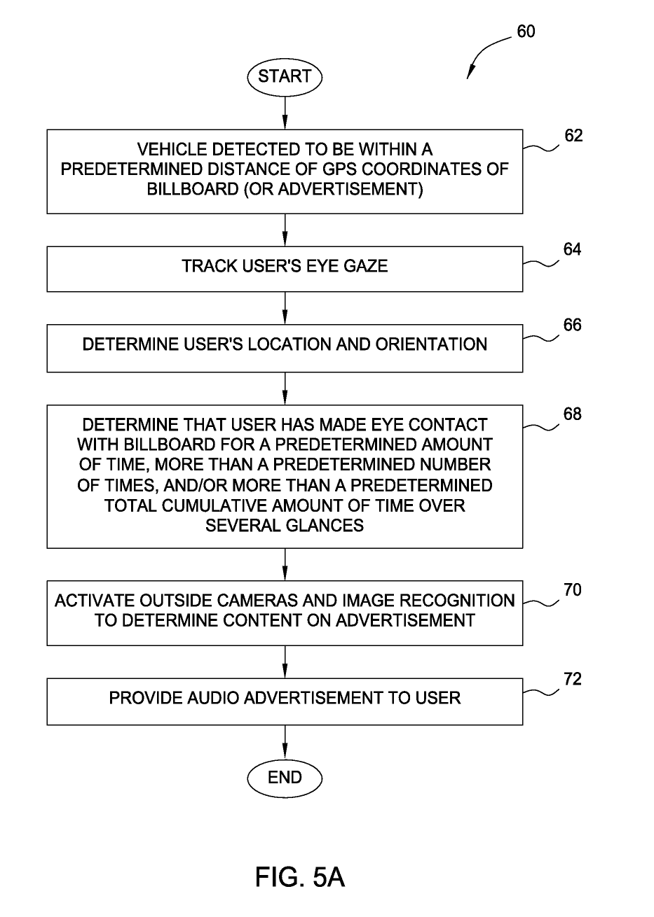

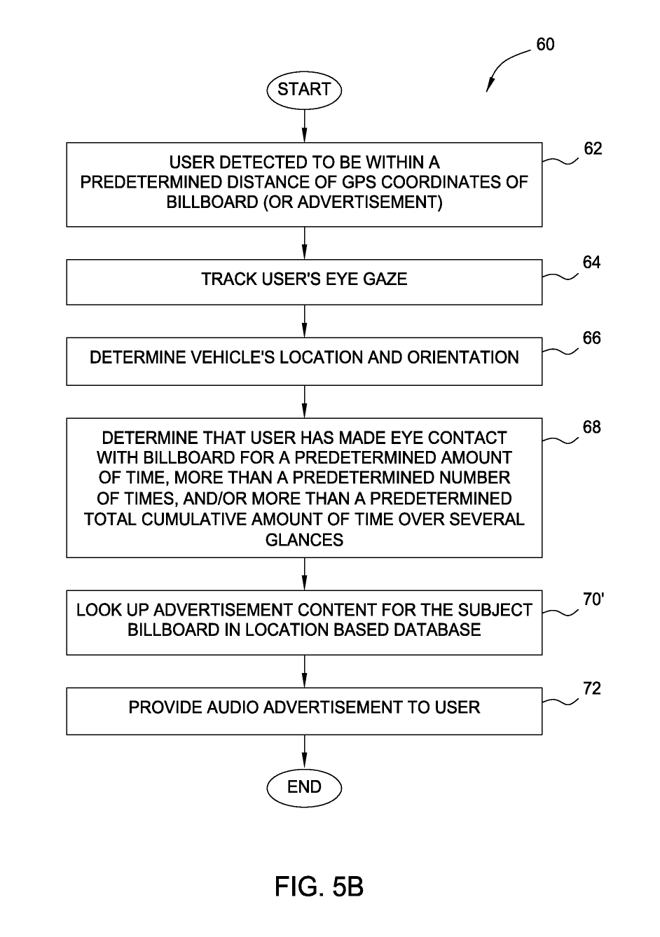

FIGS. 5A and 5B depict methods 60 and 60′ that the system 10′ can implement for providing an audio advertisement that is related to an advertisement that a user sees. In operation 62, the eye gaze tracker system 14 can determine whether the vehicle 16 is positioned within a predetermined distance (e.g., within 500 m or some other suitable value) from an advertisement 12 (e.g., a billboard). For example, the eye gaze tracker system 14 can receive the vehicle location (or vehicle GPS coordinates) from the in-vehicle GPS 18 and can search the database 30 for advertisements with locations (e.g., GPS coordinates of billboards) proximate to the GPS coordinates of the vehicle. Once the eye gaze tracker system 14 determines that the vehicle 16 is positioned within the predetermined distance of the advertisement 12 based on the information received from the in-vehicle GPS 28 and the database 30, the method 60 can proceed to operation 64.

In operation 64, the eye gaze tracker system 14 can track the eye gaze direction of the driver 22. Alternatively, the eye gaze tracker system 14 can track the orientation of the head of the driver 22.

In operation 66, the eye gaze tracker system 14 can determine GPS coordinates and direction of the vehicle 16 in response to the eye gaze tracker system 14 tracking the eye gaze of the driver 22.

In operation 68, the eye gaze tracker system 14 can determine if the driver 22 has looked at the advertisement 12 for a predetermined amount of time, a number of times exceeding a predetermined amount, and/or for a total cumulative time exceeding a predetermined amount to determine whether the driver 22 is interested in an advertisement. If the driver 22 is interested, then the method 60 can proceed to operation 70 (in FIG. 5A) or operation 70′ (in FIG. 5B).

Referring to FIG. 5A, in operation 70′, the eye gaze tracker system 14 can recognize the context of the advertisement by controlling or activating the camera(s) 20 to capture an image of the advertisement 12 and performing image recognition of the same. As noted above, the camera(s) 20 can include any combination of hardware and software for capturing the image of the advertisement 12 and for performing image recognition.

Referring to FIG. 5B, in operation 70′, the eye gaze tracker system 14 can recognize the context of the advertisement by accessing the database 30 and retrieving the context of the advertisement at a location that intersects with the detected eye gaze direction of the driver 22. Put differently, the database 30 can be accessed to obtain the GPS coordinates for geocoded billboard locations (e.g., provided by advertising companies, etc.) and match the vehicle's current location (as provided by the in-vehicle GPS 28) and the gaze direction of the driver 22 against the geocoded billboard locations to ascertain the advertisement of interest to the driver 22.

In operation 72, the infotainment system 18 can output an audio advertisement related to the visual advertisement 12 to the driver 22.

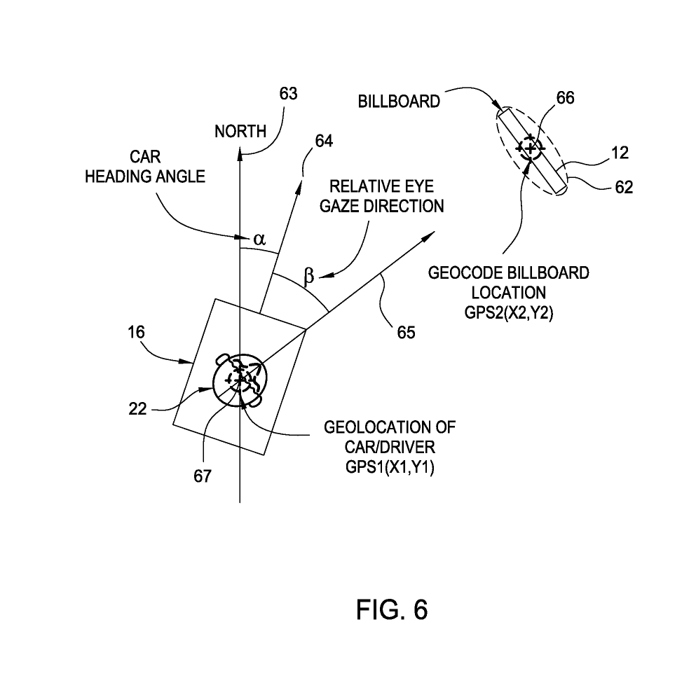

FIG. 6 depicts an exemplary scenario in which a system, such as system 10 in FIG. 2 or system 10′ in FIG. 4, can determine whether a user (e.g., the driver 22) is looking at the billboard 12. For example, in a vehicle 16 (e.g., a passenger car), the system 10 or 10′ can determine a direction 64 with an angle α of the vehicle 16 relative to a reference direction 63, such as magnetic north. The system 10 or 10′ may determine the angle α by using a compass or by computing a direction of travel from successive GPS positions. The system 10 or 10′ can also determine a direction 65 of the driver's eye gaze and/or head orientation having an angle β relative to the vehicle 16, wherein the angle β is in relation to angle α. For example, the angle β can be relative to the travel direction (indicated by angle α). By combining the angle β with the angle α, by adding β to or subtracting β from α, the angle α+β can be expressed relative to the reference direction, such as magnetic north. The system 10 or 10′ can also determine a GPS location 67 (i.e., geolocation) of the vehicle 16 and the GPS locations 66 (i.e., geolocations) of any advertisements (e.g., billboard 12) proximate to the vehicle 16. The system 10 or 10′ can calculate a vector with an origin at the GPS coordinates of the vehicle 16 and a direction equal to the angle α+β. If the vector intersects the GPS coordinates of the billboard 12 (or intersects a region 62 that surrounds the billboard 12), then the system can determine that the driver 22 is looking at the billboard 12.

If the system 10 or 10′ determines that the driver 22 has looked at and is interested in the advertisement 12, then the camera(s) 20 can capture an image of the advertisement 12 for use by the infotainment system 18 to determine a context of the advertisement. The infotainment system 18 can then provide an audio related advertisement via in-vehicle speakers 24 that is associated with the advertisement 12 as viewed by the driver 22. As noted above, it is recognized that the infotainment system 18 may include an audio system for interfacing with the in-vehicle speakers 24 for playing back the audio related advertisement or may be implemented as an Aha® radio station by Harman® in which such information is played back either via the driver's 22 cell phone or through the in-vehicle speakers 24 via an interface with the driver's 22 cell phone. In addition, the infotainment system 18 may be coupled to the wireless connection 26 for communication with the server (not shown). The server may provide the audio related advertisement via the wireless connection 26 to the infotainment system 18 for playback to the driver 22.

It is recognized that the audio related advertisement may be customized based on the location of the vehicle 16 and vehicle heading direction. For example, if the vehicle 16 is traveling towards San Francisco and the driver 22 is interested in a billboard advertisement for a particular vehicle manufacturer (e.g., Toyota, Ford, etc.), then the audio related advertisement may be customized to include location information for the vehicle manufacturer's dealership on the driver's 22 route or destination including dealer hours of operation, etc. Still further, the audio related advertisement may be customized to include an initial quote on a new car, assuming the driver 22 may trade in his/her current vehicle 16 and details (such as the current vehicle's 16 model, make, year, current mileage via the vehicle's 16 diagnostic data) are made available for transmission via the wireless connection 26. A navigation system (not shown) in the vehicle 16 may receive information such as the location of a point of interest as detailed by the audio related advertisement so that the driver 22 has the option of adding the point of interest to his/her current route.

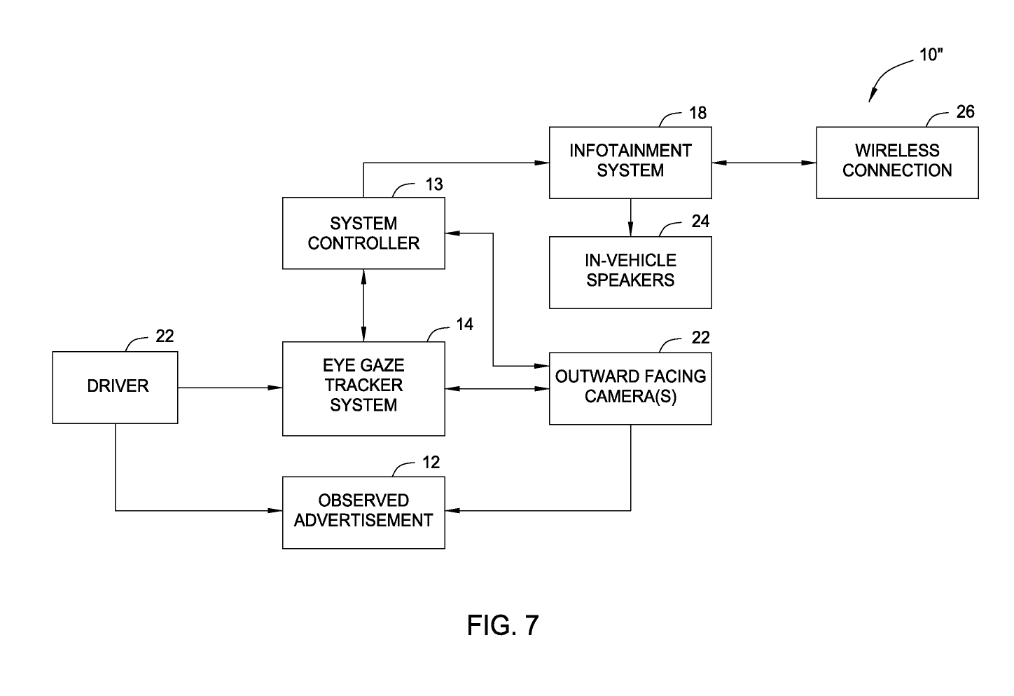

FIG. 7 depicts another embodiment of a system 10″ for providing audio advertisements to a driver 22 that relate to a visual advertisement 12. The system 10″ can include camera(s) 20 that can detect an image of the visual advertisement 12. The system 10″ can also include an eye gaze tracker system 14, which can determine an eye gaze direction of the driver 22. As noted above, the eye gaze tracker system 14 can determine whether the driver 22 has looked at the advertisement 12 for more than the predetermined amount of time, a number of times exceeding a predetermined amount, and/or for a total cumulative time exceeding a predetermined amount to determine whether the driver 22 is interested in the visual advertisement 12. If the driver 22 is interested in the advertisement 12, an infotainment system 18 can then provide an audio related advertisement via in-vehicle speakers 24 that is associated with the context of the advertisement 12 as viewed by the driver 22 and captured by the camera(s) 20.

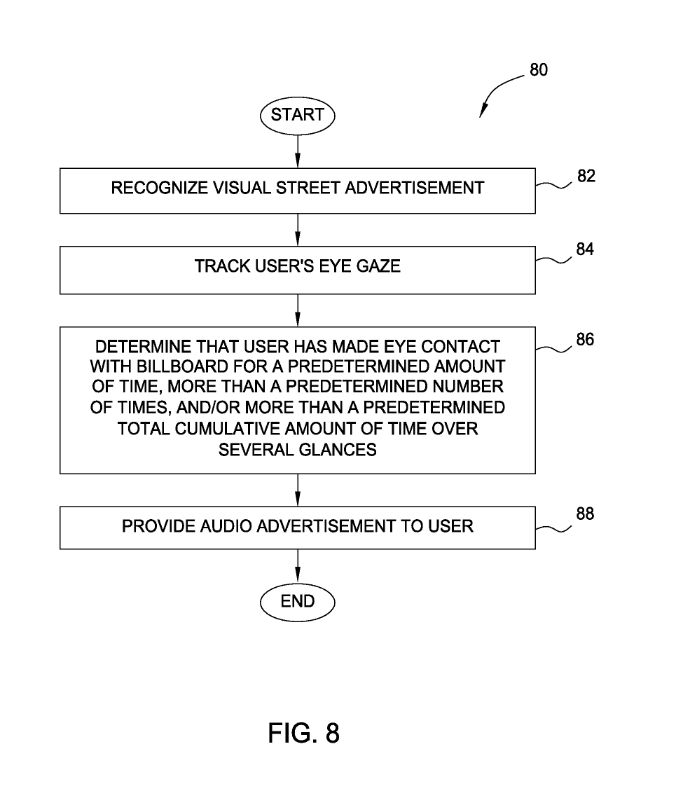

FIG. 8 depicts a method 80 that the system 10″ of FIG. 7 can implement for providing audio advertisements to a driver 22 that relate to a visual advertisement 12. In operation 82, the camera(s) 20 can scan the environment proximate to the system 10″ for images of advertisements (e.g., an image of advertisement 12). In operation 84, the eye gaze tracker system 14 can track the eye gaze direction of the driver 22. In operation 86, the eye gaze tracker system 14 can determine whether the driver 22 is interested an advertisement by determining whether the driver 22 has looked at the advertisement for a predetermined amount of time, a number of times exceeding a predetermined amount, and/or for a total cumulative time exceeding a predetermined amount. If the driver 22 is interested in the advertisement, then, in operation 88, the infotainment system 18 can provide an audio related advertisement via in-vehicle speakers 24 that is associated with the context of the advertisement 12.

In general, additional embodiments may include an apparatus that provides visual information on one or more in-vehicle displays (e.g., center console, instrument cluster, heads up display (HUD), passenger displays, etc.) that either adds visual information along with the audio stream or that replaces the audio stream. While the sensors used in connection with the eye gaze tracker system 14 may be mounted on the vehicle 16 to measure eye gaze direction or head orientation, the sensors may be (i) attached to glasses of the driver 22, (ii) attached to the driver's necklace (e.g., “amulet device,” may appear as jewelry pendent), (iii) worn on a wrist watch, (iv) worn on a head band or head ring, (v) worn anywhere on the body), (vi) attached to clothing, such as a belt buckle, etc., (vii) positioned on driver's mobile device (e.g., smartphone, tablet, etc.), (viii) portable and attachable/removable to/from the vehicle 16 (e.g., bicycle, motorcycle, etc.)

Additional embodiments include (i) improving customization by taking advantage of the driver's 22 preferences (e.g., from his/her social media presence), (ii) adding a button or verbal command to the apparatus that indicates “remind me later!” and either transmitting the information from the billboard or the audio advertisement to the driver 22 via e-mail or other social media channels, (iii) allowing any one or more apparatuses to notify the advertising agency of interest to the driver, which allows for the advertising agency to follow up with the driver later regarding the interest in their product, (iv) communicating with an external device for additional processing power (e.g., a smartphone, a smart watch or connect directly to remote servers using a wireless network).

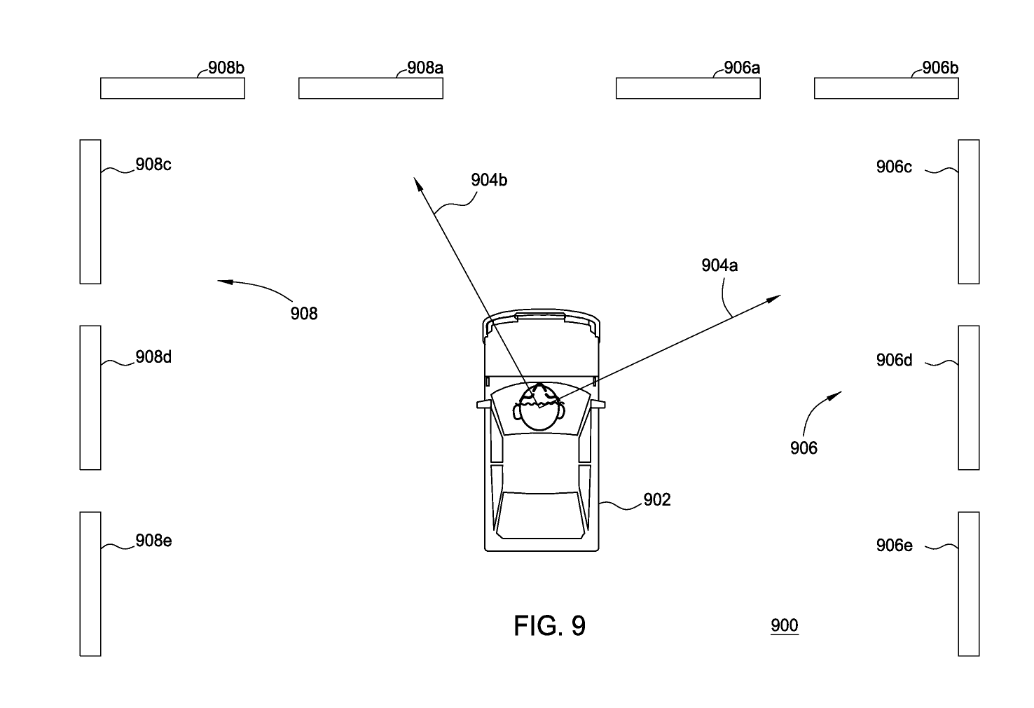

FIGS. 9, 10, and 11 depict additional scenarios in which a system (e.g., system 10, system 10′, or system 10″) may determine which advertisement a user is looking at and/or the context of an advertisement that the user is looking at. FIG. 9 depicts a vehicle 902 traveling in an environment that includes a plurality of closely-spaced advertisements (e.g., billboards) 906 and 908 surrounding the vehicle 902. For example, FIG. 9 may depict a vehicle 902 driving through Times Square in New York City, in which advertisements are densely arranged side-by-side and vertically. In such a scenario, using GPS to determine the location of the vehicle 902 and to computer a vector based on the GPS location and the direction of the driver's eye gaze may not work properly because inherent error in the GPS location calculation may result in the system identifying the wrong advertisement. To illustrate, FIG. 9 includes an arrow 904a, which indicates a possible eye gaze direction of the driver of the vehicle 902. If a calculated GPS location indicates that the car is located as it is shown in FIG. 9, then the system will determine that the driver is looking at advertisement 906c. However, if the system determines that the vehicle 902 is behind the position shown in FIG. 9 (due to calculated GPS location error), then the system may erroneously determine that the driver is looking at advertisement 906d or 906e. Due to the GPS location calculation error, a system that tracks eye gaze direction and direction(s) to visually-detected advertisements may be implemented in a scenario such as that shown in FIG. 9. As shown in FIG. 9, one or more scene cameras can capture images of the environment around the vehicle 902, including images of the advertisements 906 to the right of the vehicle 902 and the advertisements 908 to the left of the vehicle. The captured images can also include images of advertisements that are vertically stacked relative to one another. The captured images of the advertisements can be oriented by the system relative to the vehicle (e.g., relative to a straight-ahead direction of the vehicle). Similarly, the direction of the vehicle driver's eye gaze and/or head orientation can be oriented relative to the vehicle. The system can determine whether the driver is looking at a particular advertisement by determining whether a direction of the driver's eye gaze corresponds to an orientation of a captured image of an advertisement. For example, if the eye gaze of the driver is in the direction of arrow 904a, then the eye gaze direction corresponds to the orientation of a captured image of advertisement 906c. Accordingly, the system can determine that the driver is looking at the advertisement 906c. Similarly, if the eye gaze of the driver is in the direction of arrow 904b, then the eye gaze direction corresponds to the orientation of a captured image of advertisement 908a. Accordingly, the system can determine that the driver is looking at the advertisement 908a.

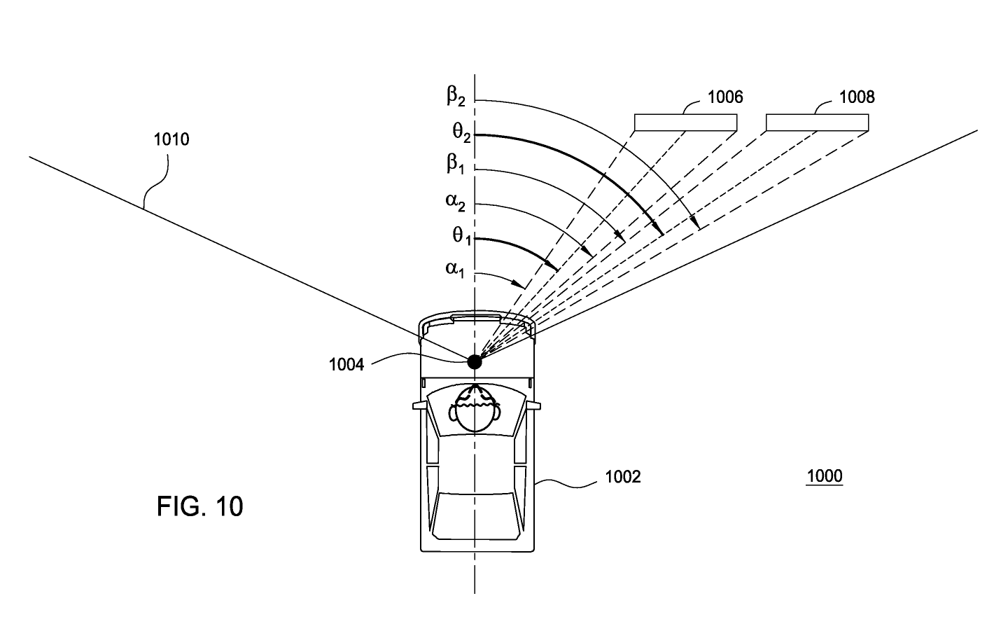

FIG. 10 illustrates a scenario in which a system (e.g., system 10, system 10′, or system 10″) can identify boundaries (e.g., borders) of a captured image of an advertisement and can determine whether the user (e.g., a driver) is looking at the advertisement by determining if the eye gaze direction of the user is within the boundaries of the advertisement. FIG. 10 illustrates a vehicle 1002 driving toward two advertisements (e.g., billboards) 1006 and 1008 that are within a field of view 1010 of an outward-facing camera. A first advertisement 1006 is oriented such that a left boundary is oriented at an angle α1 relative to a direction of travel of the vehicle and a right boundary is oriented at an angle α2 relative to the direction of travel of the vehicle. Thus, if an eye gaze direction θ1 of the user is between angle α1 and angle α2, then the system may determine that the driver is looking at the first advertisement 1006. Similarly, a second advertisement 1008 is oriented such that a left boundary is oriented at an angle β1 relative to a direction of travel of the vehicle and a right boundary is oriented at an angle β2 relative to the direction of travel of the vehicle. Thus, if an eye gaze direction θ2 of the user is between angle β1 and angle β2, then the system may determine that the driver is looking at the first advertisement 1006. In a similar manner, the system may identify vertical boundaries (e.g., top and bottom boundaries) of an advertisement and determine whether a vertical eye gaze direction of the user is between the vertical boundaries of a particular advertisement. In certain environments, such as Times Square in New York City, where advertisements are closely spaced both side by side and vertically, a system may identify both horizontal and vertical boundaries of each advertisement, and a user may be determined to be looking at a particular advertisement if the eye gaze direction is at a horizontal angle and vertical angle within the boundaries of the advertisement. For purposes of clarity, FIG. 10 illustrates a point of view 1004 from which angles (or orientations) to the advertisements and eye gaze direction are all determined. In practice, the location of the user's eyes may differ from the location of the outward-facing camera(s), which may require the system to perform a calculation or transformation to align the two points of view.

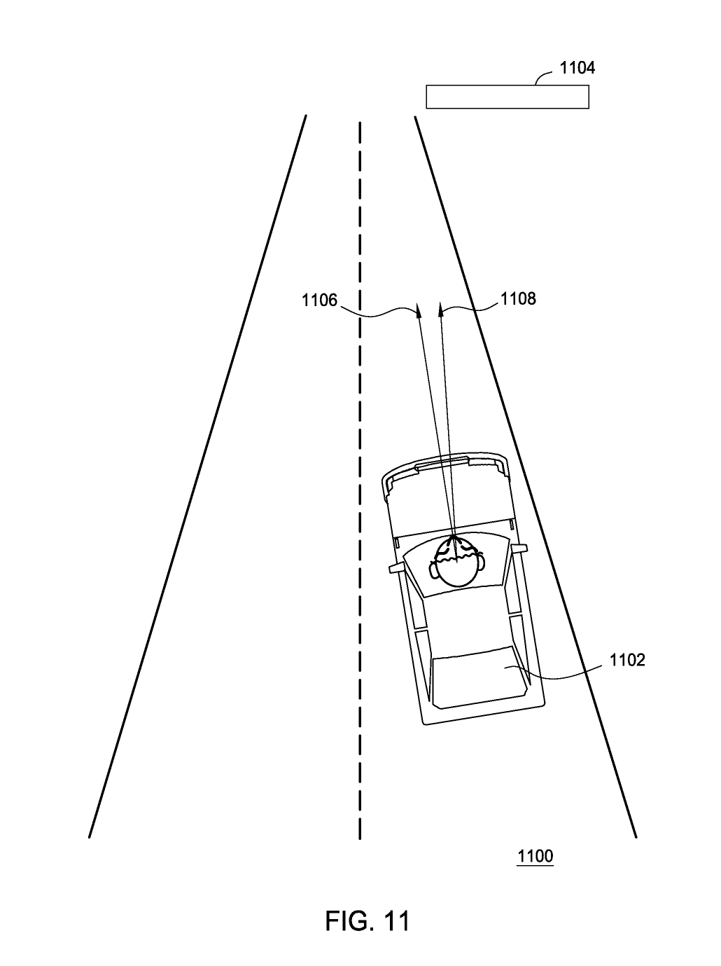

FIG. 11 depicts an exemplary scenario in which a system (e.g., system 10, system 10′, or system 10″) identifies a distant advertisement being looked at by a user (e.g., a driver of a vehicle 1102) and identifies the context of the advertisement. In the scenario, the user is driving along a road 1100 toward a single, distant billboard 1104. There are no other billboards 1104 in the area, but the billboard is too distant for the driver or an outward-facing camera to identify the content of the billboard. Also, because the billboard 1104 is distant, an eye gaze tracker system 14 could be ineffective since any errors in determining eye gaze direction 1106 or 1108 and/or head orientation could result in the system miscalculating whether the user is looking at the billboard 1104. In one part of operation, the system can identify the lone billboard 1104 as being relatively proximate to the vehicle 1102 (by searching a database for billboards with geolocations proximate to the GPS location of the vehicle 1102). Since the proximate environment includes no other billboards, the system could infer that any eye gaze direction toward the side of the road is directed to the billboard 1104. For example, FIG. 11 depicts a first arrow 1106 corresponding to an eye gaze direction of straight ahead along the road 1100 and a second arrow 1108 corresponding to an eye gaze direction toward the side of the road 1100. If the eye gaze direction is toward the side of the road, then the system may infer that the user is looking at the advertisement that is known to be along the side of the road. Also, at a distance, the apparent size of the billboard 1104 may be too small for an outward-facing camera to identify objects, images, and/or text in the billboard to identify a context of the advertisement. Again, the system may access the database that includes the geolocation of the billboard 1104 to identify a context of the billboard. As described above, a context for the billboard may be stored in the database. As a result, the system may begin to play an audio advertisement that is related to the context of the billboard 1104 when the billboard 1104 is detectably visible, but before the details of the billboard 1104 are discernible to the user. In general, the user may be visually aware of the advertisement. However, the billboard may be too far away to comprehend the context of it. The system may survey the proximate environment, the environment surrounding the user, and play any audio advertisements (or other audio information) as the user approaches the billboard 1104.

As described above, the audio advertisements can be related to the context of visual advertisements in a user's environment. In an exemplary scenario, when driving, an advertisement (or billboard) for a new smart phone may catch a driver's attention. The driver may look at the advertisement several times, attempting to understand all of the details included in the advertisement. A system as disclosed herein, can recognize that the driver is interested in the advertisement and capture an image of the advertisement. Using image detection and recognition techniques, the apparatus can detect the content of the advertisement and retrieves an appropriate audio stream. Additionally, using an in-vehicle navigation system data, the audio stream retrieved may be customized by the driver's location, heading direction, navigation destination, and exact route. The system can initiate a streaming process of an audio advertisement about the new smartphone through the car's loud speakers. The audio advertisement could provide the driver with additional information about the new product, including the most convenient location where to purchase the phone given the driver's current location, route, and destination.

In another exemplary scenario, a driver may be heading north toward San Francisco and may view an interesting advertisement for a new Toyota model on an outdoor LED display. The driver may glance at the advertisement multiple times (in an effort to remember the various details). As a result of the driver's multiple viewings of the advertisement, a system according to various embodiments, may play an audio advertisement from Toyota with details of the subject car of the advertisement, including customized details about the Toyota dealer closest to the user's route, or the destination in San Francisco (e.g., using data pulled from the navigation system). By using internal data related to the driver's current vehicle (e.g., make, model, year, mileage, etc.), the system may play an audio advertisement that may include an initial quote in case the driver wants to trade in his current vehicle for the new Toyota model. In this case, by simply pressing a button (or the like) on the infotainment system, the driver may add the suggested Toyota dealer as a waypoint or an endpoint on his route.

One or more aspects disclosed herein provide the driver with an opportunity to hear details of a visual advertisement instead of having to read them, thereby reducing distraction and enabling the driver to keep his the eyes on the road. In view of the foregoing, audio advertisements may be meaningful and tailored to what the driver is showing interest in. Moreover, the audio advertisement can be customized based on the driver's vehicle and location.

In addition, one or more aspects disclosed herein may (i) reduce the driver's cognitive load and distraction while driving a vehicle thereby improving safety, (ii) improve the quantity and quality of information that limited visual advertisements can provide, and (iii) deliver customized details to interested drivers. Thus, advertisements may be more effective, convey more information and be directed to interested drivers. From the driver's standpoint, advertisements are selected to match their interests while reducing distractions and providing additional contextual information that matters specifically to him/her.

One or more aspects disclosed herein provide two complementary systems. One system may be a camera-based system, which surveys the proximate environment for advertisements or the like and uses an eye gaze tracker system to detect and track the gaze of a driver, allowing for an infotainment system to provide an audio advertisement based on the advertisement a driver has been viewing in the driver's proximate environment. A second system may be a location-based system that determines the location of the vehicle and the advertisements in the proximate environment through the use of a GPS, allowing for the infotainment system to determine the advertisements surrounding the driver and the eye gaze tracker to determine which billboard the driver is viewing before playing the audio advertisement for the driver. Each system may work independently or the two systems can work cooperatively. For example, each system may provide a determination of which advertisements a user may be interested in and what the context of those advertisements may be. The resulting determinations may be cross-checked against each other to ensure accurate operation of the system.

In the above-described exemplary scenarios, the systems are primarily described with respect to passenger vehicles and drivers. Systems can also be incorporated in portable and/or wearable portions used by a pedestrian, bicyclist, or the like. For example, an audio transducer can be incorporated into headphones or ear buds worn by a pedestrian. Similarly, an eye tracking camera and an outward facing camera can be incorporated into eyewear (e.g., sunglasses, prescription glasses, or head-mounted displays such as Google Glass®). The computer logic and/or computer processor can be incorporated into a dedicated housing and/or may be incorporated into a smart phone or the like. For example, the computer logic can be implemented as an application that runs on a smart phone, tablet, or other portable computer device.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A controller for providing audio information, the controller comprising:
a first signal input configured to receive a first camera signal that indicates a direction in which a user is looking;
a second signal input configured to receive a second camera signal that includes captured images of one or more visual information;
a signal output configured to drive at least one acoustic transducer; and
computer logic programmed to:
determine a direction to each of the captured images of the one or more visual information;
determine whether the indicated direction in which the user is looking corresponds to the determined direction of the captured image of one of the one or more visual information; and
upon determining that the indicated direction in which the user is looking corresponds to one of the one or more visual information:
determine a context of the one of the one or more visual information; and
output to the signal output an audio information related to the context of the one of the one or more visual information.

2. The controller of claim 1, wherein a first camera is connected to the first signal input, wherein at least one second camera is connected to the second signal input, wherein at least one acoustic transducer is connected to the signal output, wherein the first camera, the at least one second camera, the at least one acoustic transducer, and the computer logic are arranged in a passenger vehicle, wherein the first camera module is arranged in a passenger compartment of the passenger vehicle to determine a direction in which the user is looking, and wherein the at least one second camera is arranged on the vehicle in an outward-facing arrangement.

3. The controller of claim 1, further comprising a data transceiver, wherein, upon determining that the user is looking at one of the one or more visual information, the computer logic retrieves the audio information from a remote database through the data transceiver.

4. The controller of claim 1, wherein the first camera detects an eye gaze direction of the user, and wherein the indicated direction in which the user is looking is the detected eye gaze direction.

5. The controller of claim 1, wherein the first camera detects a head orientation of the user, including a direction in which the head of the user is facing, and wherein the indicated direction in which the user is looking is the detected direction in which the head of the user is facing.

6. The controller of claim 1, wherein the computer logic further determines whether the user is interested in one of the one or more visual information by at least one of:
determining that the user has looked in the direction of the one of the one or more visual information for at least a predetermined amount of time;
determining that the user has looked in the direction of the one of the one or more visual information more than a predetermined number of times; and
determining that the user has looked in the direction of the one of the one or more visual information for a total cumulative amount of time that exceeds a predetermined amount,
receiving an input signal from a user interface (e.g., physical button, icon on a digital interface, etc.);
and wherein the computer logic outputs the audio information upon determining that the user is interested in the one of the one or more visual information.

7. The controller of claim 1, wherein the at least one acoustic transducer comprises an audio speaker arranged in a vehicle.

8. A wearable controller for providing audio information, the controller comprising:
a first signal input configured to receive a first camera signal that indicates an eye gaze direction;
a second signal input configured to receive a second camera signal that includes captured images of one or more visual information;
a signal output configured to drive at least one acoustic transducer; and
computer logic programmed to:
determine a direction to each of the captured images of the one or more visual information;
determine whether the indicated eye gaze direction corresponds to the determined direction of the captured image of one of the one or more visual information; and
upon determining that the indicated eye gaze direction corresponds to one of the one or more visual information:
determine a context of the one of the one or more visual information; and
output to the signal output an audio information related to the context of the one of the one or more visual information,
wherein a first camera that provides the first camera signal, the at least one second camera that provides the second camera signal, and the at least one acoustic transducer are arranged in at least one wearable housing.

9. The controller of claim 8, wherein the first camera is arranged on a head-mounted device that is wearable.

10. The controller of claim 8, wherein the at least one acoustic transducer is arranged in headphones, and wherein the at least one second camera is arranged in a housing for the headphones.

11. The controller of claim 10, wherein the computer logic is arranged in the housing for the headphones.

12. The controller of claim 10, wherein the computer logic is arranged in a smart phone.

13. The controller of claim 8, further comprising a data transceiver, wherein, upon determining that the indicated eye gaze direction corresponds to the determined direction of the captured image of one of the one or more visual information, the data transceiver transmits the captured image of the one of the one or more visual information to a remote computer system and receives the audio information from the remote computer system.

14. A computer readable medium comprising a program which, when executed by one or more processors, performs an operation comprising:
determining a direction in which a user is looking;
determining locations for a plurality of visual information relative to the user;
determining whether the user is looking in a direction corresponding to one of the plurality of visual information;
determining a context of the one of the plurality of visual information; and
outputting an audio information related to the context of the one of the plurality of visual information to the user.

15. The computer readable medium of claim 14, wherein determining a direction in which the user is looking comprises determining a direction of eye gaze of the user relative to a reference direction, wherein determining locations for the plurality of visual information relative to the user comprises determining at least one direction to each of the plurality of visual information relative to the reference direction, and wherein determining whether the user is looking in a direction corresponding to one of the plurality of visual information comprises determining whether the direction of eye gaze is within a predefined threshold of the at least one direction of the one of the plurality of visual information.

16. The computer readable medium of claim 15, wherein determining at least one direction to each of the plurality of visual information comprises determining a first direction relative to the reference direction that corresponds to a first boundary of each of the plurality of visual information and determining a second direction relative to the reference direction that corresponds to a second boundary of each of the plurality of visual information, wherein the second boundary is opposite the first boundary, and wherein determining whether the direction of eye gaze is within a predefined threshold of the at least one direction of the one of the plurality of visual information comprises whether the determined eye gaze direction is between the first direction and the second direction of the one of the plurality of visual information.

17. The computer readable medium of claim 16, wherein determining at least one direction to each of the plurality of visual information further comprises determining a third direction relative to the reference direction that corresponds to a third boundary of each of the plurality of visual information and determining a fourth direction relative to the reference direction that corresponds to a fourth boundary of each of the plurality of visual information, wherein the third boundary is orthogonal to the first boundary, wherein the fourth boundary is opposite the third boundary, and wherein determining whether the direction of eye gaze is within a predefined threshold of the at least one direction of the one of the plurality of visual information comprises whether the determined eye gaze direction is between the third direction and the fourth direction of the one of the plurality of visual information.

18. The computer readable medium of claim 14, wherein determining a context of the one of the plurality of visual information comprises:
receiving an image of the one of the plurality of visual information;
comparing the received image to a plurality of images in a database, wherein each image in the database is associated with a context; and
upon matching an image from the database to the received image, associating the context of the matched image from the database with the one of the plurality of visual information.

19. The computer readable medium of claim 14, wherein determining a context of the one of the plurality of visual information comprises:
determining a geolocation of the one of the one or more visual information;
querying a database that comprises a plurality of georeferenced visual information, wherein each georeferenced visual information is associated with a context; and
upon matching the determined geolocation with a georeferenced visual information, associating the context of the matched georeferenced advertisement with the one of the plurality of visual information.
